(19) United States
(12) Patent Application Publication
(10) Pub. No.: US 2012/0294257 A1
(43) Pub. Date: Nov. 22, 2012

(54) METHOD, BASE STATION AND CORRESPONDING MOBILE STATION FOR OBTAINING DOWNLINK CHANNEL DIRECTIONAL INFORMATION

(75) Inventors: Yi ZHANG, Beijing (CN); Yuantao ZHANG, Beijing (CN); Hua ZHOU, Beijing (CN); Jun TIAN, Beijing (CN); Jianming WU, Beijing (CN)

(73) Assignee: FUJITSU LIMITED, Kawasaki-shi (JP)

(21) Appl. No.: 13/541,336

(22) Filed: Jul. 3, 2012

Related U.S. Application Data
(63) Continuation of application No. PCT/CN2010/070085, filed on Jan. 8, 2010.

(51) Int. Cl. H04W 72/04

(52) U.S. Cl. 370/329

(57) ABSTRACT

Disclosed in the present invention is a method in the Multiple Input Multiple Output system for obtaining downlink channel directional information. The method includes steps: a base station receives downlink channel directional information which is fed back by a mobile station during the feedback period, and determines the relation between an uplink channel directional information and the received downlink channel directional information; the base station also estimates the downlink channel directional information of non-feedback sub-frame by use of the relation, those non-feedback sub-frame are not fed back during the feedback period. Furthermore, a base station and corresponding mobile station in MIMO system are also provided in the present disclosure.

### CROSS-REFERENCE TO RELATED APPLICATIONS

The present application is a continuation of PCT Application No. PCT/CN2010/070085, filed on Jan. 8, 2010, the content of which is incorporated herein by reference for all purposes.

### FIELD OF THE INVENTION

The disclosure generally relates to a wireless communication field, in particular to a method, base station and corresponding mobile station for obtaining downlink channel directional information in Multiple Input Multiple Output (MIMO) system.

### BACKGROUND OF THE INVENTION

A wireless communication system transmits and receives a signal in a designated electromagnetic spectrum; however, the capacity of the electromagnetic spectrum is limited. With increasing demands for wireless communication systems, there is increasing challenge of improving utilization efficiency of the spectrum. In order to improve the communication capacity of the system and limit the transmission power, a variety of wireless communication technologies are proposed, for example, MIMO technology. In those technologies, space channel status information usually needs to be fed back to a base station by a mobile station, and this feedback cost may be high.

### SUMMARY OF THE INVENTION

A brief summary about the present disclosure is provided hereinafter to provide basic understandings related to some aspects of the present disclosure. It shall be understood that this summary is not an exhaustive summary related to the present disclosure. The summary is not intended to determine a key part or an important part of the present disclosure, nor does it intend to limit the scope of the present disclosure. The purpose of the summary is only to provide some concepts in simplified forms to prelude more detailed descriptions discussed later

The disclosure aims to reduce feedback cost in MIMO system.

To this end, one object of the disclosure is to provide a method and base station for obtaining downlink channel directional information, by means of which feedback cost may be reduced in MIMO system.

To achieve the above goal, according to one aspect of the disclosure, a method of obtaining downlink channel directional information in MIMO system is provided, the method including: receiving downlink channel directional information fed back by a mobile station in accordance with a feedback period, determining a relation between uplink channel directional information and the received downlink channel directional information; and estimating, by use of the relation, downlink channel directional information of a sub-frame which is not fed back in the feedback period.

According to another aspect of the disclosure, a base station in the MIMO system is further provided, the base station including: a downlink channel information obtaining unit configured to receive downlink channel directional information which is fed back by a mobile station in accordance with a feedback period, a relation determining unit configured to determine a relation between uplink channel directional information and the received downlink channel directional information; and a downlink channel information estimating unit configured to estimate, by use of the relation determined by the relation determining unit, downlink channel directional information of a sub-frame which is not fed back in the feedback period.

According to another aspect of the disclosure, a mobile station is further provided, the mobile station including: a feedback period receiving unit configured to receive information on a feedback period from a base station, and a downlink channel information feedback unit configured to feedback the downlink channel information to the base station in accordance with the feedback period.

According to other aspect of the disclosure, a corresponding computer program code, a computer readable storage medium and a computer program product are further provided.

The disclosure has an advantage that it is not necessary for the mobile station to feedback frequently the downlink channel directional information to the base station, and the base station may estimate subsequent downlink channel directional information that is not fed back according to the downlink channel directional information fed back by the mobile station, thereby reducing greatly feedback cost, without influencing evidently the communication quality.

Those and other advantages of the disclosure will be more apparent by detail explanations of the best embodiments of disclosure provided by referring to the Figure.

### BRIEF DESCRIPTION OF THE DRAWINGS

The disclosure may be understood better by referring to description provided in conjunction with the drawings, wherein the same or similar reference signs are used to represent the same or similar components in all of the Figure. The Figures and the following detailed description are included in the Description and form a part of the Description, and they are used to further explain preferable embodiments of the disclosure and explain principle and object of the disclosure by examples. In the Drawings:

FIG. 1 illustrates a structure schematic view of a multi-user MIMO system in the prior art.

FIG. 2 illustrates downlink channel information fed back by the mobile station to the base station in the prior art.

FIGS. 3a-3c illustrate schematically a principle diagram of the disclosure.

FIG. 4 illustrates a flow chart of the method of the disclosure.

FIG. 5 illustrates downlink channel information fed back by the mobile station to the base station according to the method of the disclosure.

FIG. 6 illustrates a schematic structure view of a base station according to an embodiment of the disclosure.

FIG. 7 illustrates a schematic structure view of a base station according to another embodiment of the disclosure.

FIG. 8 illustrates a schematic structure view of a base station according to another embodiment of the disclosure.

FIG. 9 illustrates schematic structure view of a mobile station according to another embodiment of the disclosure.

FIG. 10 is a block diagram illustrating an example structure of a universal personal computer that may implement the method and/or device according to embodiments of the disclosure.

### DETAILED DESCRIPTION OF THE INVENTION

Example embodiments of the disclosure will be described in conjunction with the Figures. For the sake of clearness and conciseness, the description does not describe all features of the actual embodiments. However, it shall be understood that decisions specific to embodiments have to be made in a procedure of developing such an actual embodiment to achieve the specific object of the developer, for example, complying with limited conditions relative to system and transaction, and those limited conditions may change in different embodiments. In addition, it shall be understood that although the developing working may be complex and time consuming, such a developing working is only routine for those skilled in the art benefit from the disclosure of the disclosure.

In addition, it shall be noted that, to avoid blurring of the disclosure due to unnecessary details, only device structures and/or process steps closely related to the solution of the disclosure are illustrated in the drawings, and other details not closely related to the disclosure are omitted.

For a multi-user MIMO communication system such as zero-forcing beam forming (ZF-BF) multi-user MIMO system and Wimax system, the disclosure proposes a method and base station for obtaining space channel directional information at low cost. In addition, the method and base station for obtaining space channel directional information at low cost proposed in the disclosure is also applicable for a single user MIMO communication system, and is applicable for both FDD system and TDD system.

To facilitate the illustration, the method and device of the disclosure are explained by taking ZF-BF multi-user MIMO communication system as an example.

Long term evolution-Advanced (LTE-A) of the next wireless communication system of 3GPP requires the downlink to provide a peak rate of 1 Gps and a peak spectrum efficiency of 30 bps/Hz, and this challenges the physical transmission solution of the system. The multiple input multiple output communication system multiplexes channels in space, improving spectrum efficiency of the system. To meet the demand of the International Telecommunication Union (ITU) better, the physical layer needs to use much more advanced technique. Multi-user multiple input multiple output (MU-MIMO) technique is one of the candidate techniques. In the MU-MIMO system, the base station transmits a plurality of data streams of different users using the same time frequency resource. It is capable of using sufficiently multi-user broadcasting channel capacity for obtaining multi-user diversity gain and meeting better the demand of LTE-A system.

The LTE-A system provides a Demodulation Reference Signal (DM-RS), which ensures realization of decoding in case of unknown pre-coding matrix (vector) at the receiving end. This characteristic simplifies the realization of advanced pre-coding technique-ZF-BF. ZF-BF technique eliminates mutual interferences among different user data streams at the transmitting end, using much more sufficiently the multi-user broadcasting channel capacity. A large number of improved ZF-BF techniques are being discussed by the standard organization, such as regularization ZF-BF technique and block diagonal ZF-BF technique. Those beaming forming solutions all require that the system is aware of the space channel status information at the base station. In Frequency Division Duplex (FDD) system, space channel status information needs to be fed back to a base station by a mobile station.

The content fed back includes downlink channel directional information and corresponding downlink channel quality information, wherein the downlink channel direction information fed back may be in the form of a space channel correlation matrix or a space channel direction vector. The feeding back of the space channel correlation matrix may be in the form of feeding back floating values, and the feeding back of the space channel directional vector may be in the form of feeding back quantization codebook instructions. For example, LTE-A system supports at most 8 antennae of the base station, and 4 antennae of the mobile station, it mostly corresponds to 8×8 space channel correlation matrix and 4 space channel directional vectors, and thus the feedback cost may be very high.

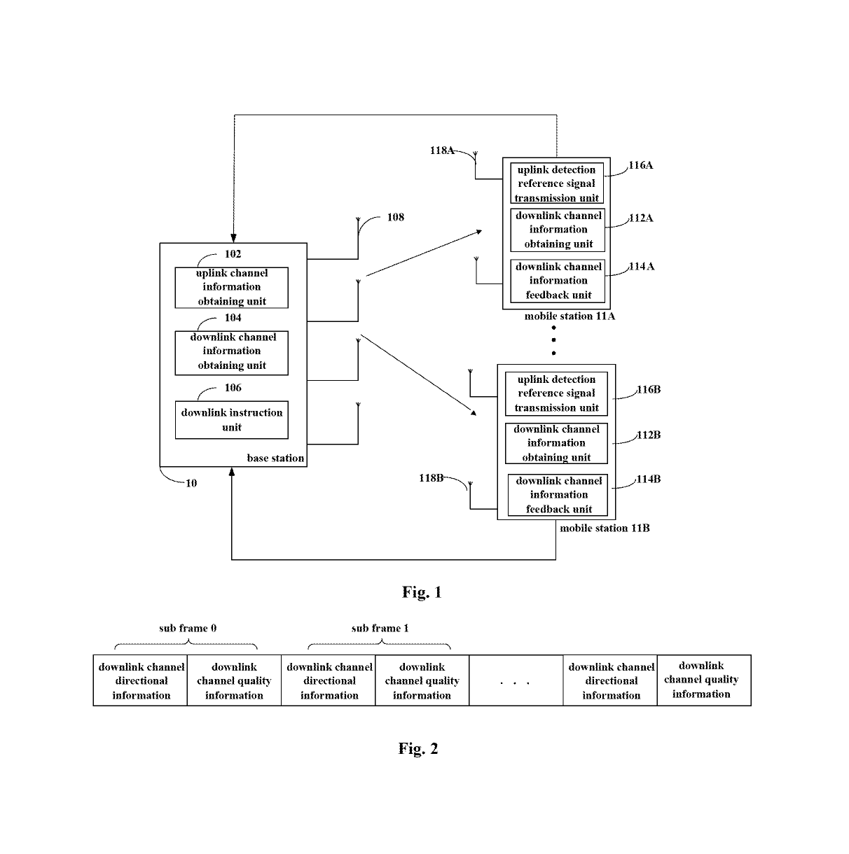

FIG. 1 illustrates a structure schematic view of a multi-user MIMO system in the prior art.

As illustrated in FIG. 1, the multi-user MIMO system includes a base station 10 and a plurality of mobile stations 11A, 11B, etc.

A base station 10 includes an uplink channel information obtaining unit 102, a downlink channel information obtaining unit 104, a downlink instruction unit 106 and a base station antennal unit 108, wherein the uplink channel information obtaining unit 102 is configured to obtain uplink channel information of each mobile station according to an uplink detection reference signal transmitted from the mobile station, the downlink channel information obtaining unit 104 is configured to obtain downlink channel information fed back by each mobile station. The downlink instruction unit 106 is configured to inform the mobile station of the configuration information.

As to the mobile station, since each mobile station usually has a similar structure and conducts similar processes, explanation will be provided only by taking the mobile station 11A as an example. The mobile station 11A includes a downlink channel information obtaining unit 112A, a downlink channel information feedback unit 114A, an uplink detection reference signal transmission unit 116A and a mobile station antenna unit 118A. Wherein the downlink channel information obtaining unit 112A is configured to obtain downlink channel information according to a reference signal received from the base station, the downlink channel information feedback unit 114A is configured to feedback the downlink channel information obtained by the mobile station to the base station, and the uplink detection reference signal transmission unit 116A is configured to transmit the uplink detection reference signal to the base station.

Since the base station needs to be aware of the downlink channel status information when scheduling or zero-forcing beam forming, in operation, the base station 10 may inform the mobile station of the configuration information through the downlink instruction unit 106. After receiving the configuration information, the mobile station feeds back the downlink channel information obtained by the mobile station to the base station 10 via the downlink channel information feedback unit 114A according to the configuration information. The base station 10 obtains downlink channel information fed back by the mobile station via the downlink channel information obtaining unit 104, and, determines, according to the obtained downlink channel information, scheduled mobile stations in the MU-MIMO system, and the time frequency transmission resource used by them, and maps the data to be sent to the scheduled user to the allocated time frequency transmission resources after the data are coded, modulated and zero-forcing beam formed, and transmits the data to the mobile station via the antenna unit 108. The transmitted signal reaches the mobile station after being transmitted through different channels. Since the mobile station conducts usually similar processes, explanation will be provided by taking the mobile station 11A as an example. The mobile station 11A receives a transmit signal using the mobile station antenna unit 118A, and obtains downlink channel status information by downlink channel information obtaining unit 112 according to reference signal received from the base station. According to the obtained downlink channel status information, the mobile station 11A performs processes such as demodulation and decoding on the received data signal, and obtains finally the useful information transmitted from the base station.

In operation, the mobile station 11A may also transmit the uplink detection reference signal to the base station 10 through the uplink detection reference signal transmitting unit 116A, and the base station 10 obtains the uplink channel information by the uplink channel information obtaining unit 102 according to the received uplink detection reference signal, so as to control modulating manner, coding manner and so on of a corresponding mobile station.

FIG. 2 illustrates schematically downlink channel information fed back by the mobile station to the base station. As can be seen from FIG. 2, the fed back downlink channel information includes downlink channel direction information and downlink channel quality information, wherein the downlink channel direction information indicates transmission direction in an equivalent space channel, while the downlink channel quality information indicates the quality (such as the gain) of the corresponding downlink channel. Since the downlink channel directional information and downlink channel quality information are fed back frequently in the prior art, the cost for feedback is very high, wherein feeding back the downlink channel directional information requests especially high cost.

The inventor has noted that the downlink channel directional information usually changes very slowly. Therefore, the inventor deems that downlink channel direction information of a subsequent sub-frame can be estimated from the previous downlink channel directional information, and it is unnecessary to feed back the downlink channel directional information frequently (for example for each sub-frame). Since the channel directional information usually includes channel correlation matrix or channel directional vector, it occupies much more transmission resources. If feedback of directional information can be reduced, feedback cost can be reduced significantly.

The disclosure has further noted that in operation the base station may obtain uplink channel direction information, for example, the uplink channel direction information is obtained from the uplink detection reference signal transmitted from the mobile station to the base station. Therefore, if a relation between the uplink channel directional information and the downlink channel directional information can be obtained, corresponding downlink channel directional information can be obtained according to the known uplink channel directional information, such that it is not necessary to feedback downlink channel directional information for each sub-frame.

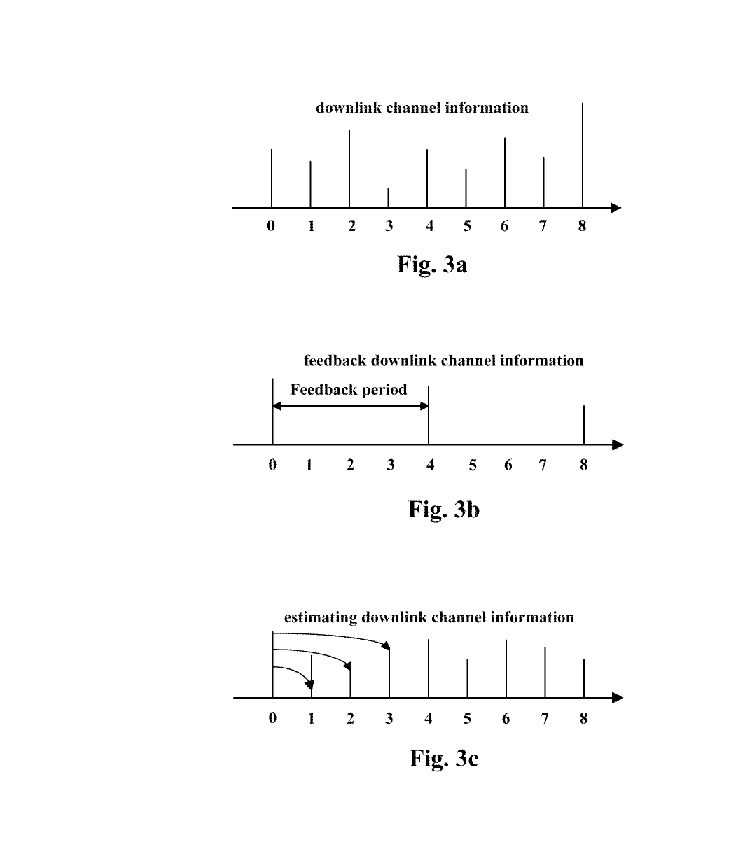

To explain the solution of the disclosure clearer, FIG. 3 schematically illustrates the principle diagram of the disclosure.

As illustrated in FIG. 3a, in the prior art, each sub-frame 0, 1, 2, . . . , 7, . . . needs the mobile station to feed back the downlink channel direction information to the base station. In the solution according to the disclosure, for example, every 4 sub-frames feedback downlink channel directional information once, that is, as illustrated in FIG. 3b, downlink channel directional information is fed back in sub-frames 0, 4, 8, . . . , that is, having a feedback period that is obviously longer than that in the prior art, thereby reducing the feedback cost. For sub-frames 1, 2, 3, 5, 6, 7 etc. for which no downlink channel directional information is fed back, the estimation is performed by the base station, as illustrated in FIG. 3c. It needs to be explained that FIG. 2 illustrates that downlink channel directional information is fed back in sub-frame 0 and sub-frame 1; however, in the prior art, it is possible that not in all sub-frames downlink channel information is fed back, for example, it is possible that the mobile station needs to only feed back in sub-frames 0, 2, 4 . . . . To facilitate illustration, the case illustrated in FIG. 2 is mainly explained. As to other cases, those skilled in the art could readily obtain corresponding solutions according to the thought provided in the disclosure. For example, if in the current solution the mobile station needs to feedback only in sub-frames 0, 2, 4, . . . , according to the disclosure, only downlink channel information in sub-frames 0, 4 . . . is fed back, and downlink channel information of sub-frames 2, 6, . . . , is estimated according to the disclosure to extend the feedback period and reduce cost, or downlink channel information in sub-frames 1, 3 . . . is estimated based on downlink channel information of sub-frames 0, 2, 4 . . . fed back in the current solution to improve communication quality.

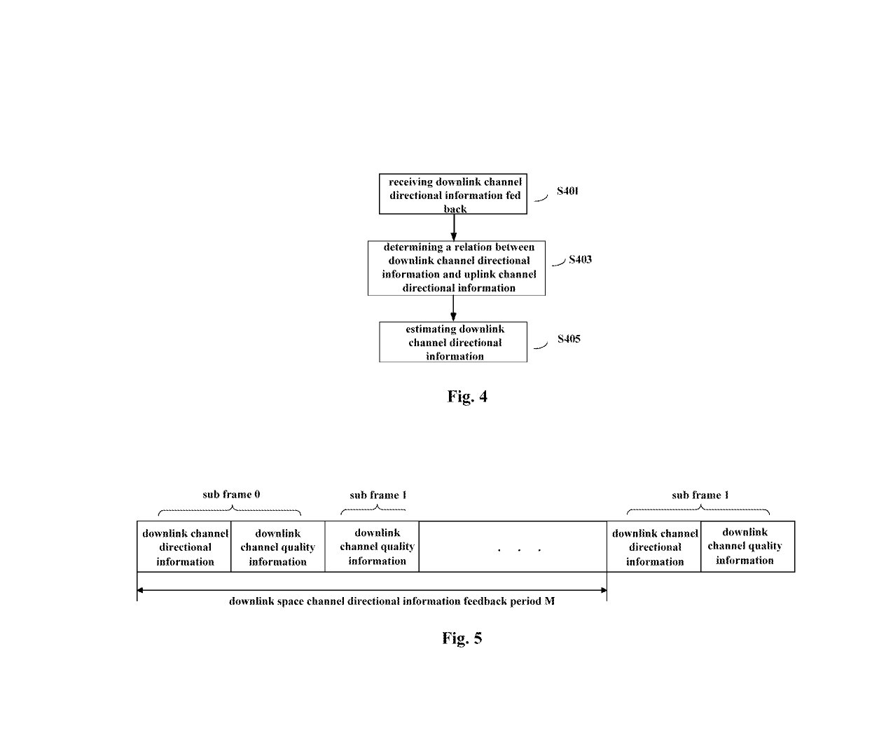

To this end, a method of obtaining downlink channel directional information in MIMO system is provided according to an embodiment of the disclosure. FIG. 4 illustrates a flowchart of the method, including the following steps: receiving the fed back downlink channel directional information, determining a relation between the uplink channel directional information and the received downlink channel directional information; and estimating the downlink channel directional information. Specific contents of the above steps are provided in detail below.

S401: The base station receives downlink channel directional information fed back by the mobile station in accordance with the feedback period. Wherein, the feedback period may be determined and sent to the mobile station by the base station according to status of the system. For example, the base station may adjust the feedback period according to the change of the uplink and downlink channels and instructs the mobile station by a broadcasting channel or a high level instruction, wherein the feedback period may be adjusted dynamically. For example: when throughput of the system reduces, the base station may reduce the feedback period to increase accuracy of the downlink channel directional information. Or, the feedback period may be a predetermined period of the system, for example, it may be prescribed that the feedback period is once or twice of the feedback in the current protocol, or it may be prescribed that every two sub-framed feedback once, every three sub-framed feed back once, etc.

S403: the base station determines a relation between the received downlink channel directional information and an uplink channel directional information, wherein the uplink channel directional information for example can be obtained from the uplink detection reference signal transmitted by the base station from the mobile station.

It needs to be explained that the downlink channel directional information may be obtained prior to the uplink channel directional information, vice verse, or they may be obtained simultaneously. The substance of the disclosure will not be influenced.

Those skilled in the art appreciate that the channel directional information may comprise space channel correlation matrix or space channel directional vector. Explanation is provided by taking the space channel correlation matrix as an example.

For example, the base station may estimate the uplink channel status information H̅ₖ(nM+m) according to the received uplink detection reference signal, wherein k is representative of a sequence number of a sub-carrier, M is representative of a feedback period of the space channel directional information, nM+m is representative of a sequence number of the sub-frame (n, m are non-negative integers). If K is set as a total number of the sub carriers used by a user, correlation matrix of uplink channel frequency domain of sub-frame nM+m may be calculated according to the following formula:

$${R}_{s} ( nM + m ) = \frac{1}{K} {\sum }_{k = 1}^{K} {\overline{H}}_{k}^{H} ( nM + m ) {\overline{H}}_{k} ( nM + m ) \qquad ( 1 )$$

In addition, if, for the zero sub-frame nM of the feedback period, the correlation matrix of the downlink channel received by the base station fed back from the mobile station is R(nM), it may be defined that the uplink and downlink channel correlation matrixes have a transform relation Tn:

Tₙ(Rₛ(nM))=R(nM) (2)

For the transform relation Tn, different models may be used to calculate based on different situations. For instance, a linear model may be used, that is, assume the transform relation Tn is a linear relation. Then the following may be obtained:

Rₛ(nM)Tₙ=R(nM) (3)

when Rₛ(nM) is reversible, it may be obtained that the linear transform relation is:

Tₙ=Rₛ⁻¹(nM)R(nM) (4)

when Rₛ(nM) is not reversible, an uplink channel is a frequency flat fading channel. At this time, the uplink channel information may be represented by H̅ₖ(nM) and then the linear transform relation is represented as:

H̅ₖ(nM)Tₙ=R(nM) (5)

With the knowledge of pseudo inverse, the linear transform relation may be obtained as:

Tₙ=R(nM) H̅ₖ^{H}(nM)( H̅ₖ(nM) H̅ₖ^{H}(nM))⁻¹ (6).

It needs to be explained that a relation Tn between uplink and downlink channel directional information is obtained by using linear model, but the disclosure is not limited to this. For example, those skilled in the art could readily establish quadratic model and ternary module, etc from the thought provided in the disclosure, and calculate correspondingly the relation Tn between the uplink and downlink channel directional information. Since it is only a routine calculation, it is not discussed in detail in the application.

In addition, it may be possible that the mobile station does not feedback directly downlink channel directional information in other feedback periods after the first feedback period, but feeds back indirectly downlink channel directional information by using an intermediate parameter, for example, it may feed back a correction parameter of the previously obtained transform relation Tn, such that the base station may correct Tn by using those correction parameters, whereby feedback cost may be further reduced.

It needs to be further explained that although it is only discussed above that in the sub-frame zero nM, the base station receives correlation matrix R(nM) for the downlink channel fed back from the mobile station, and determines Tn using the R(nM) and corresponding correlation matrix Rₛ(nM), the disclosure is not limited by this. For example, it may be possible that correlation matrixes R(nM), R(nM+1) may be obtained in sub-frame zero nM and the sub-frame 1 nM+1 of the feedback period, and Tn is determined by using R(nM), R(nM+1) and Rₛ(nM), Rₛ(nM+1) etc.

In addition, those skilled in the art appreciate that the channel directional information may also comprise space channel directional vector. For the space channel directional vector, it may be calculated by replacing correspondingly the space channel correlation matrix in the formulae (2)-(6). And this may be conceived and implemented by those skilled in the art easily, and thus detailed descriptions are omitted here.

S405: after a relation Tn between the received downlink channel directional information and uplink channel direction information is determined through the information of sub-frame zero of the feedback period, the base station estimates downlink channel directional information of non-feedback sub-frame nM+m

Also take space channel correlation matrix as an example, assume the downlink channel correlation matrix R(nM+m) is not fed back by the mobile station, the base station may estimate downlink channel correlation matrix of the sub-frame nM+m by the following formula:

R(nM+m)=Rₛ(nM+m)Tₙ (7)

For space channel directional vector, those skilled in the art may also obtain readily a corresponding estimating method.

After obtaining the correspondingly estimated downlink channel direction information, the base station may perform processes such as scheduling, zero forcing beam forming by combining downlink channel directional information and downlink channel quality information fed back from the mobile station, and the above are techniques well known to those skilled in the art, and detailed descriptions are omitted here.

It can be seen from the above method that the mobile station does not need to feedback frequently the downlink channel directional information to the base station, and the base station may estimate downlink channel directional information of subsequent non-feedback sub-frames according to the downlink channel directional information fed back from the mobile station, thereby increasing the feedback period and reducing the feedback period.

It needs to be pointed out that due to configuration not all sub-frames feedback downlink channel direction information in the prior art, for example, the mobile station may feedback in sub-frames 0, 2, 4, . . . , the method according to the disclosure may apply correspondingly, for example, it may be set that the feedback period is 4 sub-frames, such that the mobile station feeds back in sub-frames 0, 4, . . . , for sub-frame 2, estimation can be also performed to extend the feedback period and reduce feedback cost, and the substance of the disclosure is not influenced.

FIG. 5 illustrates downlink channel information fed back from the mobile station to the base station according to the method of the disclosure. As compared with FIG. 2, it can be seen that downlink channel directional information and downlink channel quality information are fed back simultaneously in sub-frame zero in a feedback period M, and only downlink channel quality information is fed back in other sub-frames in the feedback period. Therefore, the mobile station may determine the transform relation Tn using downlink channel directional information fed back in the sub-frame zero by using the method illustrated in FIG. 4, thereby estimating downlink channel directional information of other sub-frames in the period, thereby reducing greatly feedback cost. As stated above, the solution of the disclosure is not limited to the case that the downlink channel directional information is fed back only in sub-frame zero as illustrated in FIG. 5, but downlink channel directional information may be fed back in a number of sub-frames, and downlink channel direction information of other sub-frames is estimated by suing the fed back information.

As mentioned above, although the method is explained with respect to the application in the LTE-A communication system, the disclosure is not limited to this. For example, the disclosure may also be applicable for other multi-user MIMO communication system such as Wimax system. In addition, the method of obtaining space channel directional information at low cost provided in the disclosure may also be applicable for single user MIMO communication system and applicable for both FDD system and TDD system.

Correspondingly, according to another embodiment of the disclosure, a base station for obtaining downlink channel directional information at low cost for use in the MIMO system is provided.

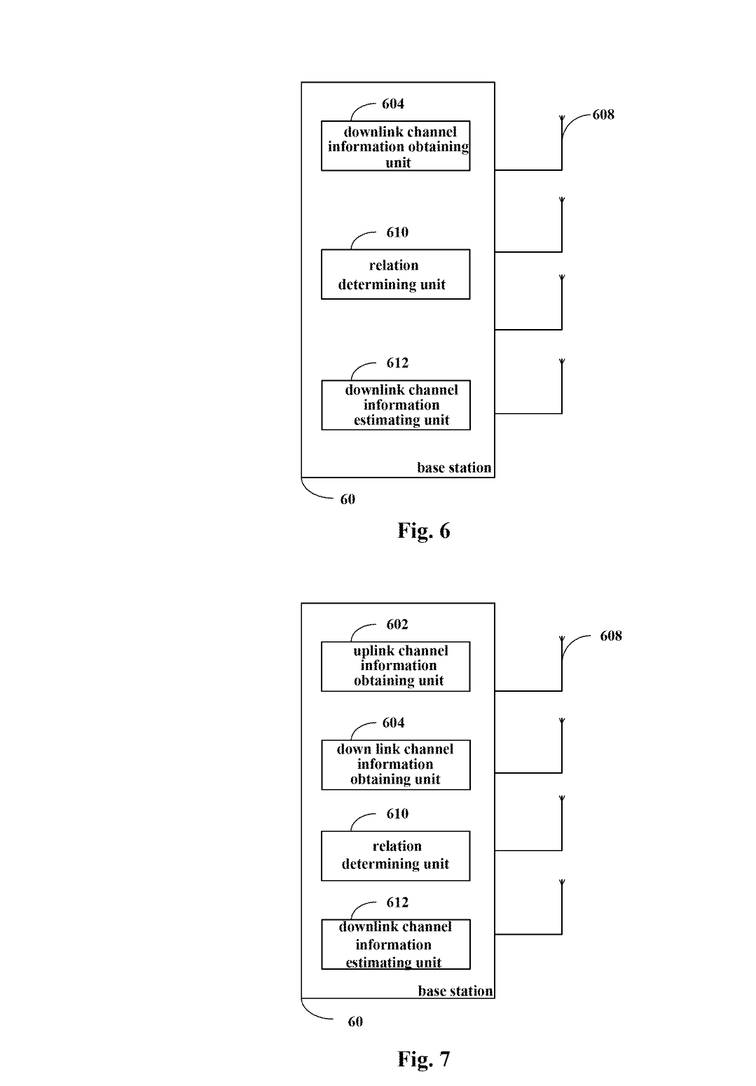

FIG. 6 illustrates a schematic structure view of a base station according to an embodiment of the disclosure, wherein the structure view illustrates only units related to the disclosure, and other details are ignored.

As illustrated in FIG. 6, the base station 60 according to the disclosure includes the following units:

a downlink channel information obtaining unit 604 configured to receive downlink channel directional information which is fed back by a mobile station in accordance with a feedback period, wherein the feedback period may be a predetermined period, for example, it may be prescribed that the feedback period is once or twice of the feedback in the current protocol, or it may be prescribed that every two sub-frames feedback once, every three sub-frames feed back once, etc.

a relation determining unit 610 configured to determine a relation between uplink channel directional information and the received downlink channel directional information.

a downlink channel information estimating unit 612 configured to estimate the downlink channel directional information of non-feedback sub-frames by use of the relation determined by the relation determining unit 610.

The base station may determine a relation Tn between the downlink channel directional information and uplink channel directional information by using the method that is described in detail above, for example, a transform relation Tn between correlation matrixes of uplink and downlink channels in sub-frame zero in the feedback period is determined by the relation determining unit 610 by using a linear model, and downlink channel correlation matrix of non-feedback sub-frames is estimated by the downlink channel information estimating unit 612. As to the specific calculation procedure, you may make reference to the above portions about the method, and details are omitted here.

Also, the disclosure is not limited to the linear model. For example, those skilled in the art could readily conceive from the thought of the disclosure of establishing a quadratic module, a ternary model, etc., and calculating correspondingly the relation Tn between the uplink and downlink channel directional information.

As stated above with respect to the method, it may also be possible that the mobile station does not directly feedback downlink channel directional information in other feedback periods after the first feedback period, and feeds back downlink channel directional information indirectly by using an intermediate parameter, for example, a correction parameter of the previously obtained transform relation Tn may be fed back, such that the base station may correct Tn by using those correction parameters, whereby feedback cost may be further reduced.

As stated above with respect to the method, the base station may determine the Tn by using, for example, downlink channel information obtained both in sub-frame zero and sub-frame 1 of the feedback period, rather than using downlink channel information fed back by sub-frame zero in the feedback period, and so on.

In addition, those skilled in the art appreciate that the channel directional information may also be e space channel directional vector. For the space channel directional vector, it may be calculated by replacing correspondingly with respect to the already described method. And this may be conceived by those skilled in the art easily, and thus detailed descriptions are omitted here.

After obtaining the correspondingly estimated downlink channel direction information, the base station may perform processes such as scheduling, zero forcing beam forming in conjunction with downlink channel directional information and downlink channel quality information fed back from the mobile station, and the above are techniques well known to those skilled in the art, and detailed descriptions are omitted here.

As can be seen from the above solution, the mobile station does not need to feedback downlink channel direction information to the base station in each sub-frame, and the base station may estimate downlink channel directional information of other non-feedback sub-frames according to the downlink channel directional information fed back from the mobile station, thereby reducing greatly the feedback cost.

FIG. 7 illustrates a schematic structure view of a base station according to another embodiment of the disclosure. Unlike the structure view illustrated in FIG. 6, the base station here further includes an uplink channel information obtaining unit 602 which is configured to obtain the uplink channel directional information, for example, the uplink channel information obtaining unit 602 may be configured to obtain the uplink channel direction information from the uplink detection reference signal transmitted from the mobile station. Whereby, the base station may obtain uplink channel station information H̅ₖ(nM+m) in the above embodiments through the uplink channel information obtaining unit 602. Since functions of other units of the base station are completely the same as those in the former embodiment, details are omitted here.

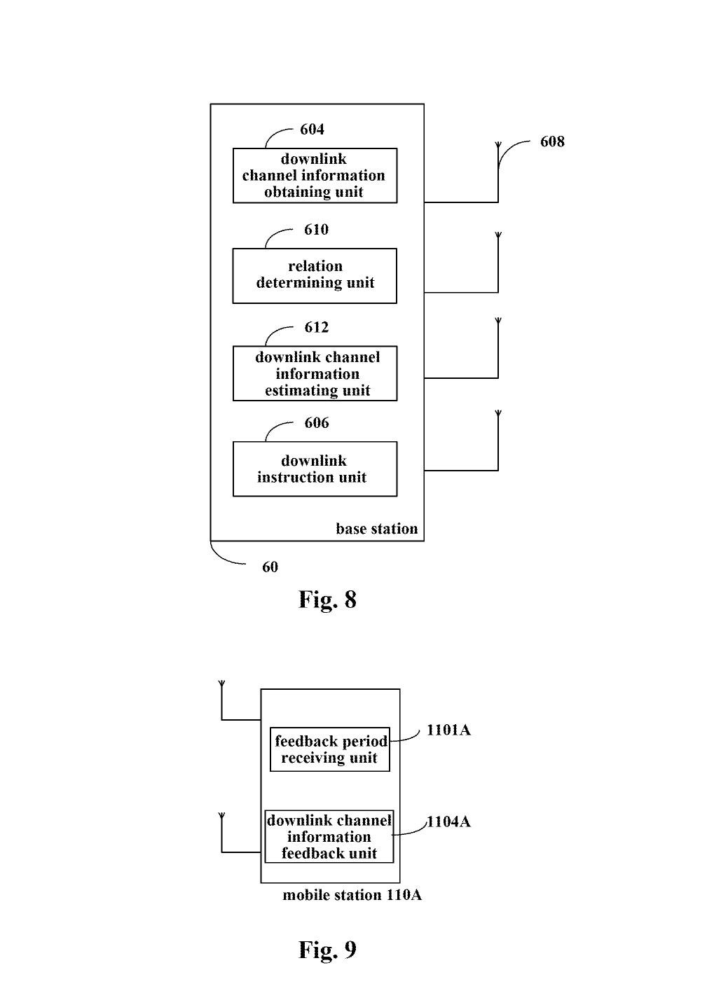

According to another embodiment of the disclosure, the feedback period where the mobile station feeds back the downlink channel directional information may be a non-predetermined period, but a period determined and sent to the mobile station by the base station based on the status of the system. For example, the base station may adjust feedback period according to the change of the uplink and downlink channels and instructs the mobile station by broadcasting channel or high level instruction, wherein the feedback period may be adjusted dynamically. As to this, FIG. 8 illustrates another schematic structure view of the base station according to the disclosure. As compared with FIG. 6, it can be seen that the base station 60 further includes a downlink instruction unit 606 which is configured to inform the mobile station of the configuration information, for example, inform the mobile station of the feedback period of the downlink channel directional information, such that the mobile station feeds back the downlink channel directional information to the base station in accordance with the feedback period. Functions executed by other units in the mobile station illustrated in FIG. 8 are completely the same as those illustrated in FIG. 6, and details are omitted here.

It needs to be explained that structures illustrated in FIGS. 7 and 8 may be combined, that is, the base station may include simultaneously the uplink channel information obtaining unit 602 and the downlink instruction unit 606 each executing functions the same as the above functions. This can be readily conceived by those skilled in the art, and details are omitted here.

It needs to be pointed out that due to configuration not all sub-frames feedback downlink channel direction information in the prior art, for example, the mobile station may feedback in sub-frames 0, 2, 4, . . . , the method according to the disclosure may apply correspondingly, for example, it may be set that the feedback period is 4 sub-frames, such that the mobile station feeds back in sub-frames 0, 4, . . . , for sub-frame 2, estimation can be also performed to extend the feedback period and reduce feedback cost, and the substance of the disclosure is not influenced.

Correspondingly, a mobile station is provided according to an embodiment of the disclosure. FIG. 9 illustrates a schematic structure view of a mobile station 110A according to the disclosure. As can be seen from the Fig., the mobile station 110A includes: a feedback period receiving unit 1001A configured to receive information on a feedback period from the base station; and a downlink channel information feedback unit 1004A configured to feedback the downlink channel directional information to the base station in accordance with the feedback period.

It may also be understood that although the method is explained with respect to the application in the LTE-A communication system, the disclosure is not limited to this. For example, the disclosure may also be applicable for other multi-user MIMO communication system such as Wimax system. In addition, the method and base station of obtaining space channel directional information at low cost provided in the disclosure may also be applicable for a single user MIMO communication system.

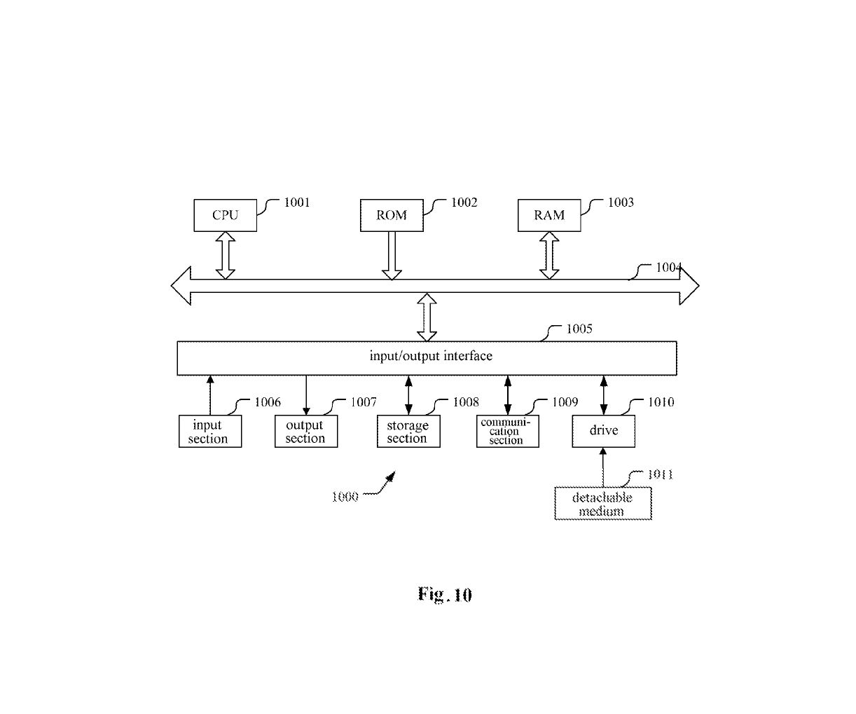

Various component modules and units of the base station may be configured by software, firmware, hardware or their combination thereof. Specific means and manners that may be used by the configuration are well known to those skilled in the art, and details are omitted here. In case of implementing the base station by software or firmware, program constituting the software may be mounted to a computer having a dedicated hardware structure from a storage medium or network (for example, the universal computer 1000 as illustrated in FIG. 10), when the computer is mounted with various program, the computer may execute various functions.

In FIG. 10, a central processing unit (CPU) 1001 perform various processes according to the program stored in the Read-Only Memory (ROM) 1002 or programs load from the storage section 1008 to the Random Access Memory (RAM) 1003. In the RAM 1003, store also data required when the CPU 1001 performs various processes. CPU 1001, ROM 1002 and RAM 1003 are connected from one to another via bus 1004. Input/output interface 1005 is also connected to the bus 1004.

The following components are connected to the input/output interface 1005: input section 1006 (including keyboard, mouse, etc.); output section 1007 (including display, such as cathode ray tube (CRT), liquid crystal display (LCD), etc., and speakers and so on); storage section 1008 (including hard disc, etc.); and communication part 1009 (including network interface cards such as LAN cards, modems and so on). The communication section 1009 performs communication process via network like the internet. According to requirements, drive 1010 is also connected to the input/output interface 1005. Detachable medium 1011 such as disc, CD, magneto-optical disc, semiconductor memory, and so on is installed on the drive 1010 based on requirements, such that the computer program read out therefrom is installed in the storage section 1008 based on requirements.

In case of implementing the above processes by software, programs constituting the software are installed from a network like the Internet or from a storage medium like the detachable medium 1011.

Those skilled in the art should be understood that such storage medium is not limited to the detachable medium 1011 which is stored with programs and distributes separate from the method to provide a user with program as illustrated in FIG. 10. The example of the detachable medium 1011 includes disc (including floppy disc (registered marks)), CD (including CD read only memory (CD-ROM) and digital versatile disc (DVD)), magneto-optical disc (including mini-disc (MD) (registered marks)) and semiconductor memory. Alternatively, the storage medium may be ROM 1002, or hard disc included in the storage section 1008 in which a program is stored and the program is distributed to a user with the method including the same.

The disclosure also provides a program product storing machine readable instruction code. When read and executed by a machine, the instruction code may implement the method according to the embodiment of the disclosure.

Correspondingly, a storage medium for carrying the program code storing the machine readable instruction code is also included in the disclosure. The storage medium includes, but not limited to, Floppy disk, CD-ROMs, magneto-optical disk, memory card, memory stick, etc.

At last, it needs to be explained that the technical terms “comprise/include” or other variants intend to cover non-exclusion inclusion, such that process, method, article of a series of elements are comprised, or the device includes not only those elements, but also other elements that are not listed evidently or further comprises the process, method, article or elements inherent in the device. In addition, in case of no more limitations, the elements defined by the sentence “comprising a . . . ” do not exclude a case that there are other the same elements in the process, method, article or device including the elements.

Although embodiments of the disclosure have been described in detail by combining with the Figure, it shall be understood that the embodiments described above are only used to illustrate the disclosure, and do not limit the disclosure. For those skilled in the art, the embodiments may be changed in various manners without departing from the substance and scope of the disclosure. Therefore, the scope of the disclosure is only defined by the attached claims and its equivalent meanings

It is not difficult to see from the above description that the following solutions are provided according to embodiments of the disclosure:
Annex 1. A method of obtaining downlink channel directional information in a Multiple Input Multiple Output MIMO system, comprising:
receiving downlink channel directional information fed back by a mobile station in accordance with a feedback period,
determining a relation between uplink channel directional information and the received downlink channel directional information; and
estimating, by use of the relation, downlink channel directional information of a sub-frame which is not fed back in the feedback period.
Annex 2. The method according to Annex 1, wherein the uplink channel directional information is obtained from an uplink detection reference signal transmitted from the mobile station.
Annex 3. The method according to Annex 1, wherein the relation between the received downlink channel directional information and uplink channel directional information is determined by using a linear model.
Annex 4. The method according to Annex 1, wherein the feedback period is a predetermined period.
Annex 5. The method according to Annex 1, further comprising determining the feedback period according to the status of the system and transmitting the feedback period to the mobile station.
Annex 6. The method according to Annex 1, wherein the channel directional information comprises a channel correlation matrix or a channel directional vector.
Annex 7. The method according to Annex 1, wherein in other feedback periods after the first feedback period, receiving downlink channel directional information fed back by the mobile station in accordance with the feedback period comprises: receiving an intermediate parameter of downlink channel directional information fed back by the mobile station, and obtaining the downlink channel directional information by using the intermediate parameter.
Annex 8. The method according to Annex 1, wherein the method is applied to a Multi-user MIMO system or a single user MIMO system.
Annex 9. A base station (60) in a Multiple Input Multiple Output MIMO system, comprising:
a downlink channel information obtaining unit (604) configured to receive downlink channel directional information which is fed back by a mobile station in accordance with a feedback period,
a relation determining unit (610) configured to determine a relation between uplink channel directional information and the received downlink channel directional information; and
a downlink channel information estimating unit (612) configured to estimate, by use of the relation determined by the relation determining unit (610), a downlink channel directional information of a sub-frame which is not fed back in the feedback period.
Annex 10. The base station (60) according to Annex 9, further comprising an uplink channel information obtaining unit (610) configured to obtain the uplink channel directional information from an uplink detection reference signal transmitted from the mobile station.
Annex 11. The base station (60) according to Annex 9, wherein the relation determining unit (610) is configured to determine a relation between uplink channel directional information and the received downlink channel directional information by using a linear model.
Annex 12. The base station (60) according to Annex 9, wherein the feedback period is a predetermined period.
Annex 13. The base station (60) according to Annex 9, further comprising: a downlink instruction unit (606) configured to determine the feedback period according to the status of the system, and transmit information on the feedback period to the mobile station (11A, 11B).
Annex 14. The base station (60) according to Annex 9, wherein the channel directional information comprises a channel correlation matrix or a channel directional vector.
Annex 15. The base station (60) according to Annex 9, wherein the downlink channel information obtaining unit (604) is configured to receive an intermediate parameter of downlink channel directional information fed back from a mobile station, and obtain the downlink channel directional information by using the intermediate parameter, in other feedback periods after the first feedback period.
Annex 16. The base station (60) according to Annex 9, wherein the base station is applied to a multi-user MIMO system or a single user MIMO system.
Annex 17. A mobile station (110A), comprising:
a feedback period receiving unit (1101A) configured to receive information on a feedback period from a base station (60), and
a downlink channel information feedback unit (1104A) configured to feedback the downlink channel information to the base station in accordance with the feedback period.
Annex 18. The mobile station according to Annex 17, wherein the downlink channel information feedback unit (1104A) is configured to feed back an intermediate parameter of the downlink channel directional information to the base station in other feedback periods after the first feedback period.
Annex 19, A program product comprising machine executable instruction, when the instruction is executed on an information processing device, the instruction makes the information processing device execute the method according to annexes 1-8.
Annex 20. A storage medium comprising machine readable program code, when the program code is executed on an information processing device, the program code makes the information processing device execute the method according to annexes 1-8.

1. A method of obtaining downlink channel directional information in a Multiple Input Multiple Output MIMO system, comprising:
receiving downlink channel directional information fed back by a mobile station in accordance with a feedback period,
determining a relation between uplink channel directional information and the received downlink channel directional information; and
estimating, by use of the relation, a downlink channel directional information of a sub-frame which is not fed back in the feedback period.

2. A base station (60) in a Multiple Input Multiple Output MIMO system, comprising:
a downlink channel information obtaining unit (604) configured to receive downlink channel directional information which is fed back by a mobile station in accordance with a feedback period,
a relation determining unit (610) configured to determine a relation between uplink channel directional information and the received downlink channel directional information; and
a downlink channel information estimating unit (612) configured to estimate, by use of the relation determined by the relation determining unit (610), downlink channel directional information of a sub-frame which is not fed back in the feedback period.

3. The base station (60) according to claim 2, further comprising an uplink channel information obtaining unit (602) configured to obtain the uplink channel directional information from an uplink detection reference signal transmitted from the mobile station.

4. The base station (60) according to claim 2, wherein, the relation determining unit (610) is configured to determine the relation between the uplink channel directional information and the received downlink channel directional information by using a linear model.

5. The base station (60) according to claim 2, wherein the feedback period is a predetermined period.

6. The base station (60) according to claim 2, further comprising: a downlink instruction unit (606) configured to determine the feedback period according to a status of the system, and transmit information on the feedback period to the mobile station (11A, 11B).

7. The base station (60) according to claim 2, wherein the channel directional information comprises a channel correlation matrix or a channel directional vector.

8. The base station (60) according to claim 2, wherein the downlink channel information obtaining unit (604) is configured to receive an intermediate parameter of downlink channel directional information, fed back from a mobile station, and obtain the downlink channel directional information by using the intermediate parameter, in other feedback periods after the first feedback period.

9. A mobile station (110A), comprising:
a feedback period receiving unit (1101A) configured to receive information on a feedback period from a base station (60), and
a downlink channel information feedback unit (1104A) configured to feed back the downlink channel direction information to the base station in accordance with the feedback period.

10. The mobile station according to claim 9, wherein the downlink channel information feedback unit (1104A) is configured to feed back an intermediate parameter of the downlink channel directional information to the base station in other feedback periods after the first feedback period.
